(19) United States
(12) Patent Application Publication
(10) Pub. No.: US 2025/0095623 A1
(43) Pub. Date: Mar. 20, 2025

(54) ANGLE INDEPENDENT ACOUSTIC STRUCTURES FOR BROADBAND SOUND ABSORPTION AND SOUND TRANSMISSION LOSS

(71) Applicants: Toyota Motor Engineering & Manufacturing North America, Inc., Plano, TX (US); Toyota Jidosha Kabushiki Kaisha, Toyota-shi Aichi-kin (JP)

(72) Inventors: Tomohiro Miwa, Toyota-shi Aichi-kin (JP); Miki Nakahara, Toyota-shi Aichi-kin (JP); Reimi Emoto, Nagoya-shi Aichi-ken (JP); Mizuki Sakamoto, Toyota-shi Aichi-ken (JP); Toyohiro Sone, Handa-shi Aichi-ken (JP); Xiaoshi Su, Ann Arbor, MI (US); Debasish Banerjee, Ann Arbor, MI (US)

(21) Appl. No.: 18/470,560

(22) Filed: Sep. 20, 2023

(51) Int. Cl. G10K 11/172; G10K 11/162

(52) U.S. Cl. CPC G10K 11/172; G10K 11/162

(57) ABSTRACT

An acoustic structure includes an acoustic scatterer with a plurality of repeating cells and a corresponding plurality of resonant channels such that the acoustic scatterer is an angle independent acoustic absorber. The plurality of resonant channels each have an open end and a terminal end, and foam extends across the open ends of the plurality of resonant channels. And a layer of foam extending around the acoustic structure and/or or positioned at open ends of the resonant channels broadens the absorption and sound transmission loss bandwidth.

### TECHNICAL FIELD

The present disclosure relates to acoustic structures that absorb sound and exhibit sound transmission loss.

### BACKGROUND

Noise pollution is an increasingly common issue across multiple environments. For example, low-frequency noise in motor vehicles is an issue related to passenger comfort. Also, sound from motors, large fans, and diesel engines, among other undesirable sounds, contribute to sound annoyance not only in the automotive industry, but also in various facets of daily life.

The present disclosure addresses issues related to sound absorption and improving sound transmission loss for acoustic structures across broad frequency ranges.

### SUMMARY

This section provides a general summary of the disclosure and is not a comprehensive disclosure of its full scope or all of its features.

In one form of the present disclosure, an acoustic structure includes an acoustic scatterer with a plurality of repeating cells and a corresponding plurality of resonant channels such that the acoustic scatterer is an angle independent acoustic absorber. The plurality of resonant channels each have an open end and a terminal end, and foam extends across the open ends of the plurality of resonant channels.

In another form of the present disclosure, an acoustic structure includes an acoustic scatterer with a plurality of repeating cells and a corresponding plurality of distinct resonant channels such that the acoustic scatterer is an angle independent broadband acoustic absorber. The plurality of distinct resonant channels each have an open end and a terminal end, and foam extends across the open ends of the plurality of distinct resonant channels.

In still another form of the present disclosure, an acoustic structure includes a cylindrical shaped acoustic scatterer with a plurality of repeating cells and a corresponding plurality of distinct resonant channels such that the cylindrical shaped acoustic scatterer is an angle independent broadband acoustic absorber. The plurality of distinct resonant channels each have an open end and a terminal end, and foam extends across the open ends of the plurality of distinct resonant channels.

Further areas of applicability and various methods of enhancing the disclosed technology will become apparent from the description provided herein. The description and specific examples in this summary are intended for illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A illustrates a perspective view of an acoustic structure with a plurality of repeating cells according to the teachings of the present disclosure;

FIG. 1B illustrates a top view of an outer foam layer extending across open ends of resonant channels of the acoustic structure in FIG. 1A according to the teachings of the present disclosure;

FIG. 1C illustrates a top view of discrete pieces of foam extending across open ends of resonant channels of the acoustic structure in FIG. 1A according to the teachings of the present disclosure;

FIG. 2A is a graph illustrating absorption as a function of soundwave frequency for the acoustic structures in FIGS. 1A-1C;

FIG. 2B is a graph illustrating sound transmission loss (STL) as a function of soundwave frequency for the acoustic structures in FIGS. 1A-1C;

FIG. 3A illustrates a perspective view of another acoustic structure with a plurality of repeating cells according to the teachings of the present disclosure;

FIG. 3B illustrates an isolated top view of one of the repeating cells of the acoustic structure in FIG. 3A;

FIG. 3C illustrates an outer foam layer extending across open ends of resonant channels of the acoustic structure in FIG. 3A according to the teachings of the present disclosure;

FIG. 3D illustrates a top view of the acoustic structure in FIG. 3A with discrete pieces of foam extending across open ends of resonant channels of the acoustic structure in FIG. 3A according to the teachings of the present disclosure;

FIG. 4A illustrates propagating soundwaves incident on acoustic scatterers according to the teachings of the present disclosure;

FIG. 4B is a graph illustrating absorption as a function of soundwave frequency for the acoustic scatterers in FIG. 4A;

FIG. 4C is a graph illustrating STL as a function of soundwave frequency for the acoustic scatterers in FIG. 4A;

FIG. 5 illustrates a top view of still another acoustic structure with a plurality of repeating cells according to the teachings of the present disclosure;

FIG. 6A illustrates propagating soundwaves incident on the acoustic structure in FIG. 5;

FIG. 6B is a graph illustrating absorption as a function of soundwave frequency for the acoustic structure in FIG. 6A;

FIG. 6C is a graph illustrating STL as a function of soundwave frequency for the acoustic structure in FIG. 6A;

FIG. 7 illustrates propagating soundwaves incident on an acoustic structure with an array of acoustic scatterers according to the teachings of the present disclosure;

FIG. 8A illustrates propagating soundwaves incident on an acoustic structure with an of acoustic scatterers having four distinct repeating resonant channels and an array of acoustic scatterers having six distinct repeating resonant channels;

FIG. 8B is a graph illustrating absorption as a function of soundwave frequency for the acoustic structure in FIG. 8A;

FIG. 8C is a graph illustrating STL as a function of soundwave frequency for the acoustic structure in FIG. 8A; and

FIG. 9 illustrates an acoustic structure with two different distinct repeating resonant channels.

It should be noted that the figures set forth herein are intended to exemplify the general characteristics of the chemical compounds, materials, and catalysts among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present disclosure provides a sound absorbing and sound transmission loss structure, also known as an acoustic structure, with at least one acoustic scatterer that absorbs soundwaves and increases Sound Transmission Loss (hereinafter STL) of the soundwaves. In addition, acoustic structures according to the teachings of the present disclosure function independent of the angle from which soundwaves are incident thereon.

In at least one variation, the acoustic structure includes a plurality of repeating cells, and each cell of the repeating cells includes at least one resonant channel configured to absorb and exhibit STL of at least one frequency of incident soundwaves. For example, in some variations each of the repeating cells has only one resonant channel, while in other variations each of the repeating cells has two or more resonant channels.

In some variations, each of the resonant channels has a zigzag pattern, for example, a lightning bolt pattern, a linear traveling pattern advancing using acute inner angles, a curved traveling pattern advancing in a concave manner, among others. Also, each resonant channel has an open end in fluid communication with a closed terminal end (also referred to herein simply as “terminal end”).

In variations where each of the repeating cells has two or more resonant channels, each of the resonant channels can be identical to the other resonant channels. In the alternative, each of the resonant channels are separate from and distinct than the other resonant channels such that each of the resonant channels have a different resonant frequency. As used herein, the term ‘distinct” refers to resonant channels that may overlap in size, composition material, and/or shape, but do not have the same resonant frequency, frequency range, frequency absorption range, frequency transmission loss range, and/or resonant frequency range. An example of resonant channels that are not distinct are resonant channels that have different colors, are made from different materials, and/or have different shapes, but have the same resonant frequency. Also, as used herein, the phrase “resonant frequency” refers to the oscillation of a resonant channel at its natural or unforced resonance and the phrase “natural resonance” refers to the frequency at which a resonant channel will oscillate in the absence of any driving force. In contrast, identical resonant channels are resonant channels that have same resonant frequency, frequency range, frequency absorption range, frequency transmission loss range, and/or resonant frequency range.

In at least one variation, the acoustic structure includes an acoustic scatterer with two cover plates attached to opposing ends thereof. In some variations, the two cover plates are permanently attached to the opposing ends of the acoustic scatterer and one or both of the cover plates can have an outer circumference that is generally equal to an outer circumference of the acoustic scatterer.

In some variations, sound projected towards the acoustic structure is at least partially reflected by the one or both of the cover plates without a phase change and the at least acoustic scatterer behaves like a monopole source at a certain distance from the cover plate(s) and its mirror image radiates a monopole moment as well. The two monopoles form a new plane wave having a direct reflection from the plate with 180° phase difference. As such, the wave reflected by the cover plate(s) is essentially canceled out by the new plane wave, thus absorbing the projected sound.

As mentioned above, the acoustic structures according to the teachings of the present disclosure absorbs soundwaves and/or exhibit STL of the soundwaves independent of the angle from which soundwaves are incident thereon. The angle independent nature of the acoustic scatterer stems from or is the result of the two or more repeating cells oriented at different angles with respect to a central axis, central line and/or central plane of the acoustic scatterer.

Not being bound by theory, for acoustically small objects such as the acoustic structure disclosed herein, background and scattered soundwaves can be decomposed into monopole and dipole components. Materials displaying a monopole response can only absorb the monopole component of the incident wave. The same limitation applies to dipole as well. However, the acoustic scatterers according to the teachings of the present disclosure exhibit monopole and dipole scattering at a similar frequency such that these two components (monopole and dipole) of the incident wave participate in the momentum exchange process and hence become available for absorption. Stated differently, the scattering strength of the monopole and dipole components are the same such that their magnitudes are the same and their scattering has constructive interference in a forward scattering direction and is canceled in a background direction.

In some variations, an angle independent acoustic scatterer (also referred to herein simply as “acoustic scatterer”) has an outer cylindrical shape, while in other variations the angle independent acoustic scatterer has a cuboidal, conical, truncated cylindrical, semi-cylindrical, and/or any symmetrical polygonal shape. The benefit of having a cylindrical shape is that sound waves that are repelled (reflected), instead of being absorbed or transmitted, may be incident upon another physical object or structure that may decrease the audible sound.

Generally, the repeating cells are positioned about a center or a central axis, central line, and/or central plane of the acoustic scatterer such that each distinct resonant channel is not directly adjacent to its pivoted counterpart in a neighboring cell. However, it is possible to have a repeating cell that is a mirror image of a neighboring cell such that the pattern of resonant channel organization repeats in inverse order.

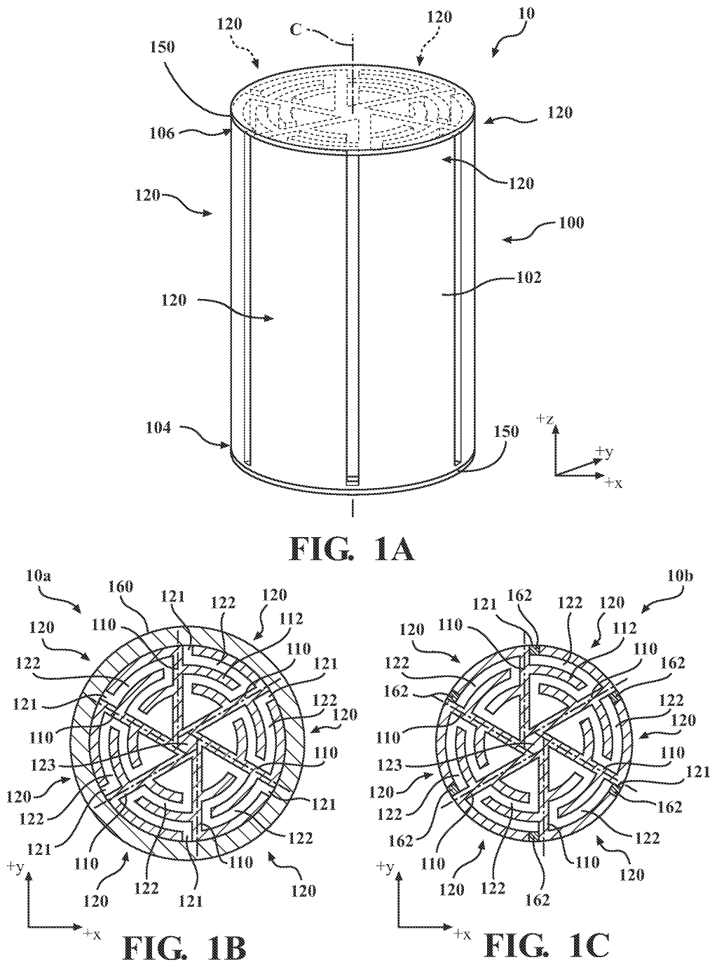

Referring to FIG. 1A, a perspective view of an angle independent acoustic structure 10 (also referred to herein simply as “acoustic structure”) according to one form of the present disclosure is shown. The acoustic structure 10 includes an acoustic scatterer 100 with six (6) repeating cells 120 that are triangular prism shaped and extend between a central axis ‘C’ and an outer surface 102. In some variations, the outer surface 102 forms or is an outer circumference of the acoustic scatterer 100. As used herein, the phrase “triangular prism shaped” refers to a geometric triangular prism with or without an outer curved surface. That is, the repeating cells 120 shown in FIG. 1A have a triangular prism shape with an arcuate outer surface 102. However, in at least one variation the repeating cells 120 can have a triangular prism shaped with a linear or planar outer surface 102.

In some variations, the acoustic scatterer 100 includes a first end 104 (e.g., a bottom (−z direction) end) permanently or semi-permanently attached to a cover plate 150. In the alternative, or in addition to, the acoustic scatterer 100 includes a second end 106 (e.g., a top (+z direction) end) permanently or semi-permanently attached to another cover plate 150. Stated differently, in some variations the acoustic structure 10 includes two cover plates 150 attached to opposing ends of the acoustic scatterer 100. As used herein, the phrase “permanently attached” refers to one object being attached to another object such the two objects cannot be separated from each other without damaging or breaking at least one of the objects. And as used herein the phrase “semi-permanently attached” refers to one object being releasably attached to another object such the two objects can be separated from each other without damaging or breaking either object.

Referring to FIG. 1B, a top view (i.e., viewing in the −z direction) of an acoustic structure 10a is shown. The acoustic structure 10a includes the acoustic scatterer 100 shown in FIG. 1A (cover plate 150 not shown) with foam 160 extending continuously along the outer surface 102 of the acoustic scatterer 100. Stated differently, a sleeve or hollow cylinder of foam 160 is disposed on the acoustic scatterer 100. The repeating cells 120 are arranged or oriented about the central axis C of the acoustic scatterer 100 and each repeating cell 120 includes at least one cell wall 110. That is, each repeating cell 120 is defined between at least one cell wall 110 and the outer surface 102 (FIG. 1A).

Each repeating cell 120 includes a resonant channel 122 defined or bounded by one or more channel walls. For example, each repeating cell 120 shown in FIG. 1B includes a resonant channel 122 defined by or extending between cell walls 110 and channel walls 112. In addition, each resonant channel 122 has an open end 121 and a terminal end 123. Stated differently, each of the resonant channels has and extends between an open end 121 and a terminal end 123.

The foam 160 extends along the outer surface 102 such that the open ends 121 of each resonant channel 122 are covered by the foam 160. In some variations, the sleeve of foam 160 is in direct contact with the outer surface 102, while in other variations the sleeve of foam 160 is spaced apart from the outer surface 102. For example, one or more layers of one or materials (including air or any other gas) can be between the outer surface 102 and an inner surface (not labeled) of the sleeve of foam 160. However, in all variations, acoustic waves propagating through space pass through the foam 160 before propagating into or entering the resonant channels 122. Naturally, any acoustic waves exiting the resonant channels 122 also pass through the foam 160.

Referring to FIG. 1C, a top view (i.e., viewing in the −z direction) of an acoustic structure 10b is shown. The acoustic structure 10b includes the acoustic scatterer 100 shown in FIG. 1A (cover plate 150 not shown) with discrete pieces of foam 162 located at the open ends 121 of the resonant channels 122 of the acoustic scatterer 100. As used herein, the term “discrete” refers to individually separate and distinct. And as shown in FIG. 1C, in some variations the foam 162 is positioned within the open ends 121 of the resonant channels 122, while in other variations the foam 162 extends across but is not positioned within the open ends 121 (not shown). In addition, and similar to the acoustic structure 10a, acoustic waves propagating through space pass through the foam 162 before propagating into or entering the resonant channels 122. Naturally, any acoustic waves exiting the resonant channels 122 also pass through the foam 162.

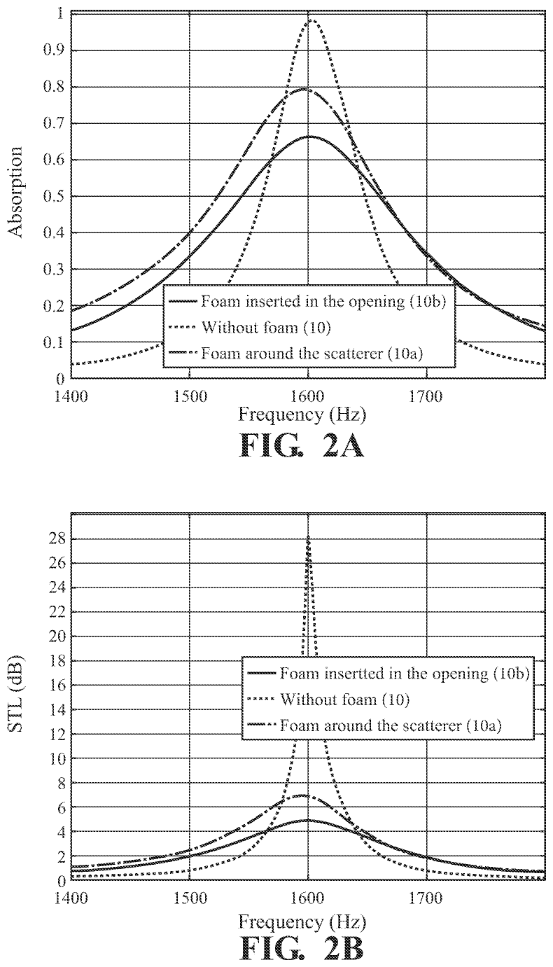

Referring now to FIGS. 2A and 2B, graphical plots of simulated acoustic wave absorption and simulated STL, respectively, as a function of acoustic wave frequency for the acoustic structures 10, 10a, and 10b, are shown. With reference to FIG. 2A, acoustic structure 10 (dotted line) exhibits about 100% absorption of acoustic waves with a frequency of about 1600 Hz but only about 10% absorption for frequencies at about 1500 Hz and about 1700 Hz. In contrast, the acoustic structure 10a (dashed line) exhibits about 80% absorption of acoustic waves with a frequency of about 1600 Hz, about 40% absorption at 1500 Hz, and about 35% absorption at 1700 Hz. And the acoustic structure 10b (solid line) exhibits about 65% absorption of acoustic waves with a frequency of about 1600 Hz, about 35% absorption at 1500 Hz, and about 35% absorption at 1700 Hz. Accordingly, the acoustic structures 10a, 10b, i.e., the acoustic structures with foam 160 or foam 162 provide broadband acoustic absorption compared to the acoustic structure 10.

With reference to FIG. 2B, acoustic structure 10 displays about 28 dB STL centered around 1.6 kHz and decreases rapidly at both higher and lower frequency ranges. Also, the acoustic structures 10b and 10c exhibit lower STL near 1.6 kHz, but decrease less compared to acoustic structure 10 at other frequencies. For example, acoustic structure 10 exhibits at least 3 dB STL from 1.55 kHz to 1.65 kHz, while acoustic structures 10a and 10b exhibit more than 3 dB STL from 1.51 kHz to1.67 kHz and from 1.53 kHz to 1.67 kHz, respectively.

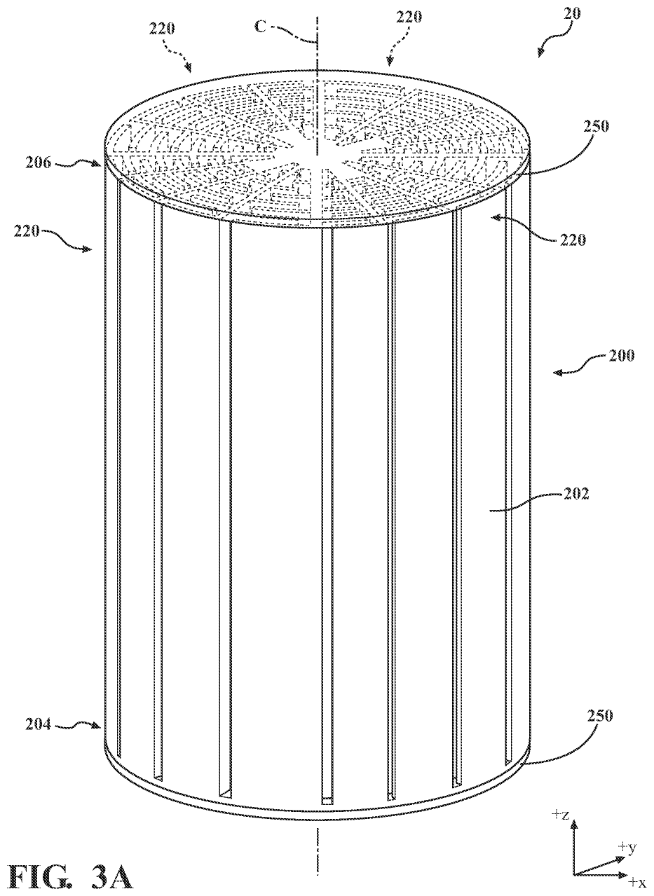

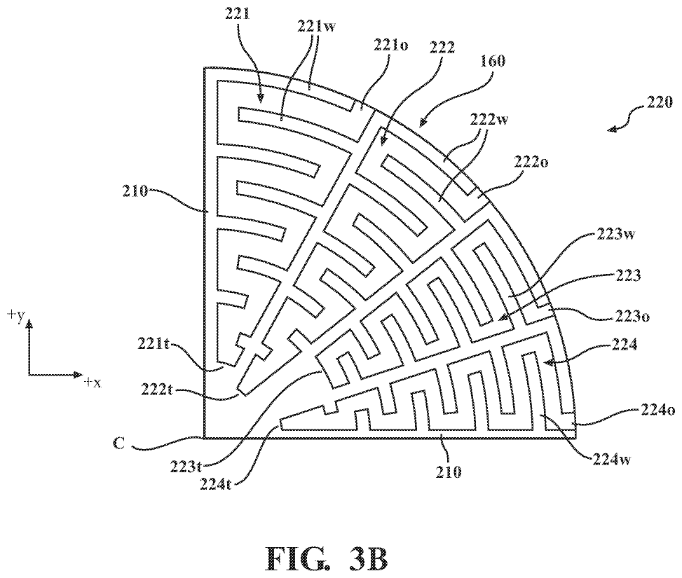

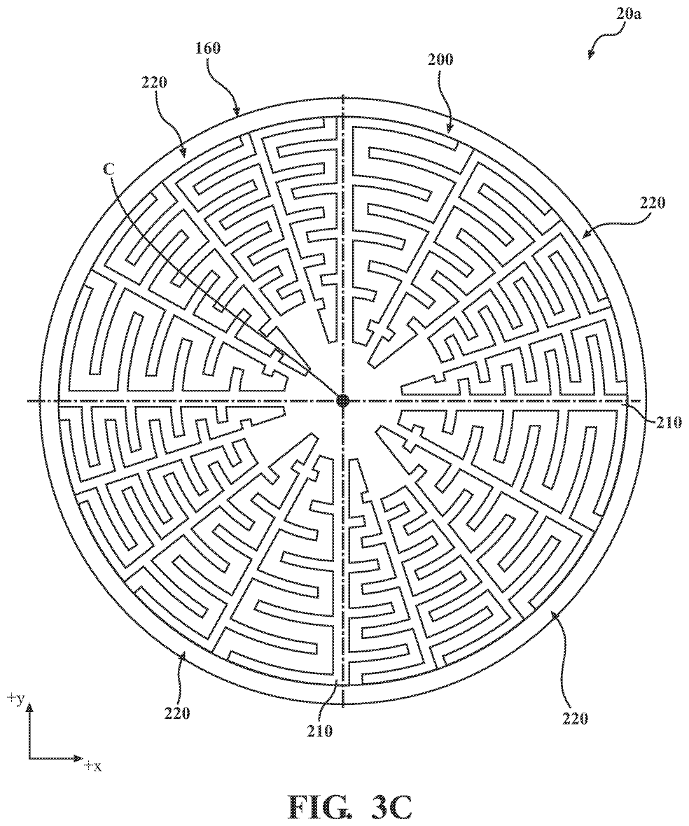

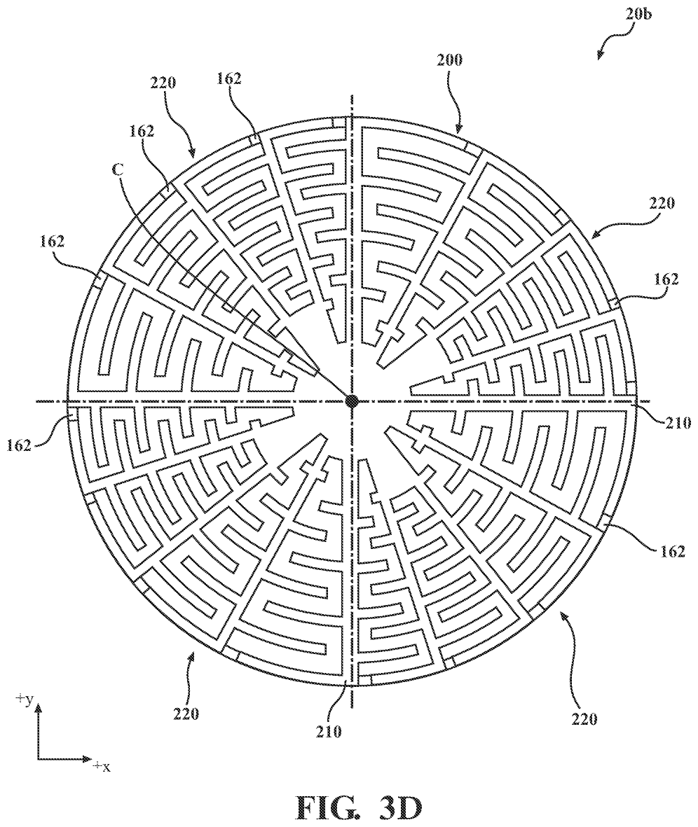

Referring now to FIG. 3A, a perspective view of an angle broadband independent acoustic structure 20 with a plurality of repeating cells 220 according to another form of the present disclosure is shown. The acoustic structure 20 includes an acoustic scatterer 200 with four (4) repeating cells 220 arranged or oriented about the central axis C of the acoustic scatterer 200. Also, in some variations the repeating cells 220 are triangular prism shaped and extend between the central axis ‘C’ and an outer surface 202. In at least one variation, the outer surface 202 forms or is an outer circumference of the acoustic scatterer 200.

In some variations, the acoustic scatterer 200 includes a first end 204 (e.g., a bottom (−z direction) cover plate) permanently or semi-permanently attached to a cover plate 250. In the alternative, or in addition to, the acoustic scatterer 200 includes a second end 206 (e.g., a top (+z direction) cover plate) permanently or semi-permanently attached to another cover plate 250. Stated differently, in some variations the acoustic structure 20 includes two cover plates 250 attached to opposing ends of the acoustic scatterer 200.

Referring to FIG. 3B, an isolated top view of one of the repeating cells 220 without the cover plate 250 is shown. Each of the repeating cells 220 include at least one cell wall 210 such that the repeating cells 220 are defined between at least one cell wall 210 and the outer surface 202. In addition, each repeating cell 220 includes a plurality of distinct resonant channels defined or bounded by one or more channel walls. For example, each repeating cell 220 includes a first resonant channel 221 defined by or extending between channel walls 221w, a second resonant channel 222 defined by or extending between channel walls 222w, a third resonant channel 223 defined by or extending between channel walls 223w, and a fourth resonant channel 224 defined by or extending between channel walls 224w. In addition, the first resonant channel 221 has an open end 2210 and a terminal end 221t, the second resonant channel 222 has an open end 2220 and a terminal end 222t, the second resonant channel 223 has an open end 2230 and a terminal end 223t, and the fourth resonant channel 224 has an open end 2240 and a terminal end 224t. Stated differently, each of the resonant channels have an open end and a terminal end.

Still referring to FIG. 3B, each of the resonant channels 221-224 is distinct, i.e., each of the resonant channels 221-224 has a resonant frequency that is different than a resonant frequency of the other resonant channels. For example, each of the resonant channels 221-224 have a distinct length, width between walls, and/or zigzag pattern such that the first resonant channel 221 has a first resonant frequency fₒ₁, the second resonant channel 222 has a second resonant frequency f₀₂, the third resonant channel 223 has a third resonant frequency f₀₃, the fourth resonant channel 224 has a fourth resonant frequency f₀₄, and fₒ₁≠fₒ₂≠fₒ₃≠fₒ₄. In addition, and with the repeating cells 220 positioned or oriented about the central axis C as shown in FIG. 3A, the acoustic structure 20 absorbs sound and increases STL independent of angles from which soundwaves approach and impact the acoustic scatterer 200.

Referring to FIG. 3C, a top view (i.e., viewing in the −z direction) of an acoustic structure 20a is shown. The acoustic structure 20a includes the acoustic scatterer 200 shown in FIG. 3A (cover plate 250 not shown) with foam 160 extending continuously along the outer surface 202 of the acoustic scatterer 200. Stated differently, a sleeve or hollow cylinder of foam 160 is disposed on the acoustic scatterer 200 and the open ends 221o-224o of the resonant channels 221-224 (FIG. 3B) are covered by the foam 160. Accordingly, the foam 160 extends across each of the open ends 221o-224o. In some variations, the sleeve of foam 160 is in direct contact with the outer surface 202, while in other variations the sleeve of foam 160 is spaced apart from the outer surface 202. For example, one or more layers of one or materials (including air or any other gas) can be between the outer surface 202 and an inner surface (not labeled) of the sleeve of foam 160. However, in all variations acoustic waves propagating through space and into any of the resonant channels 221-224, pass through the foam 160 before propagating into or entering the resonant channels 221-224. Naturally, any acoustic waves exiting the resonant channels 221-224 also pass through the foam 160.

Referring to FIG. 3D, a top view (i.e., viewing in the −z direction) of an acoustic structure 20b is shown. The acoustic structure 20b includes the acoustic scatterer 200 shown in FIG. 3A (cover plate 250 not shown) with discrete pieces of foam 162 discretely located at the open ends 221o-224o of the resonant channels 221-224 of the acoustic scatterer 200. And as shown in FIG. 3D, in some variations the foam 162 is positioned within the open ends 221o-224o of the resonant channels 221-224, while in other variations the foam 162 extends across but is not positioned within the open ends 221o-224o (not shown). In addition, and similar to the acoustic structure 20a, acoustic waves propagating through space pass through the foam 162 before propagating into or entering the resonant channels 221-224. Naturally, any acoustic waves exiting the resonant channels 221-224 also pass through the foam 162.

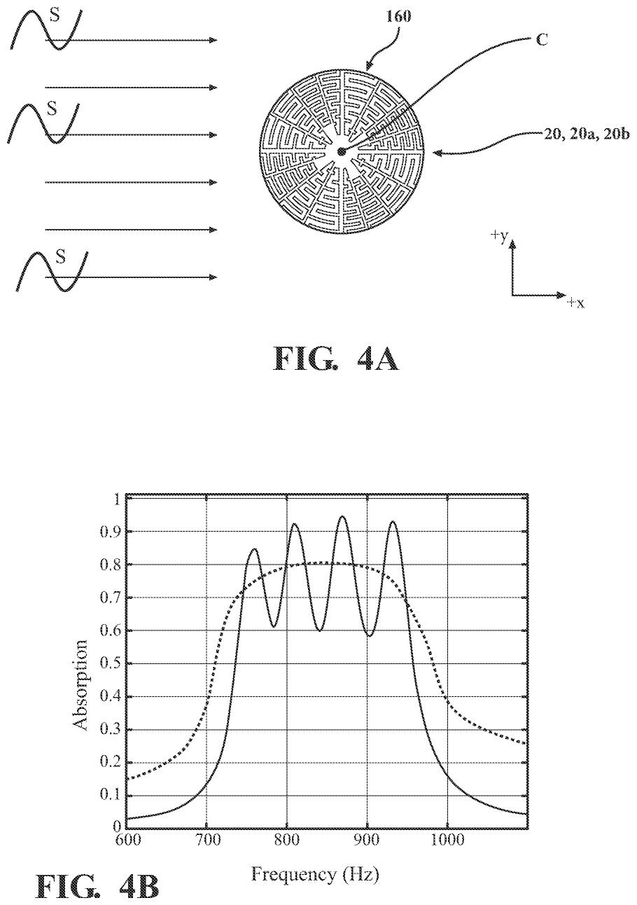

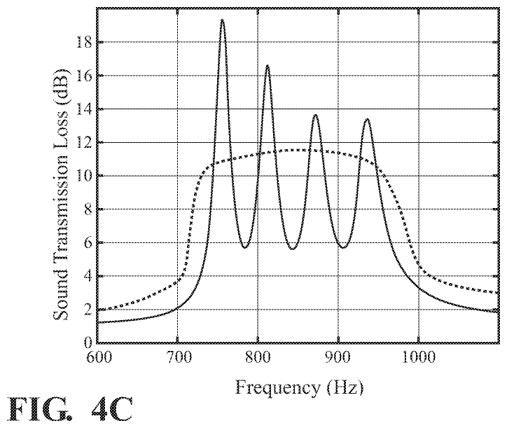

Referring to FIGS. 4A-4C, soundwaves ‘S’ with frequencies between about 600 Hz and about 1100 Hz propagating towards the acoustic structures 20, 20a, 20b (cover plate 250 not shown) in the +x direction is illustrated in FIG. 4A, the simulated absorption of the soundwaves S as a function of frequency by the acoustic structures 20 and 20a is shown in FIG. 4B, and the simulated STL of the soundwaves S as a function of frequency by the acoustic structures 20 and 20a is shown in FIG. 4C.

Referring specifically to FIG. 4B, the acoustic structure 20 (solid line) provides broadband absorption of the soundwaves S with an average absorption of about 75% for frequencies between about 750 Hz and about 950 Hz, and even higher absorption at frequencies of about 760 Hz, 810 Hz, 865 Hz, and 925 Hz. In addition, the acoustic structure 20a provides an increase or broader broadband absorption of the soundwaves S compared to the acoustic structure 20, reduced absorption at the frequencies of about 760 Hz, 810 Hz, 865 Hz, and 925 Hz, and increased absorption between the frequencies of about 760 Hz, 810 Hz, 865 Hz, and 925 Hz. For example, the acoustic structure 20a provides about 40% absorption for frequencies of about 700 Hz and about 1000 Hz, with higher absorption between 700 Hz and 1000 Hz, whereas the structure 20 provides about 12% absorption at 700 Hz and 15% absorption at 1000 Hz. And as observed from FIG. 4C, the acoustic structure 20 provides STL of about 19 dB at about 750 Hz, 16.5 dB at 810 Hz, 13.5 dB at 865 Hz, and 13.5 dB at 925 Hz, while the acoustic structure 20a provides an increase or broader STL compared to the acoustic structure 10, reduced STL at the frequencies of about 750 Hz, 810 Hz, 865 Hz, and 925 Hz, and increased STL between the frequencies of about 750 Hz, 810 Hz, 865 Hz, and 925 Hz.

It should be understood that while FIGS. 4B-4C show simulated absorption and STL for the acoustic structure 20a, similar results are provided by the acoustic structure 20b. It should also be understood that the orientation or positioning of the four repeating cells 220 about the central axis C of the acoustic scatterer 200 provides absorption and increased STL for soundwaves S propagating towards the acoustic structures 20a, 20b at different angles relative to the +x axis. That is, with the repeating cells 220 spanning 360° about the central axis C, and each of the repeating cells containing the four resonant channels 221-224, the acoustic structures 20a, 20b absorb soundwaves and increase STL for soundwaves propagating towards the acoustic structures 20a, 20b from any x-z direction shown in the figures.

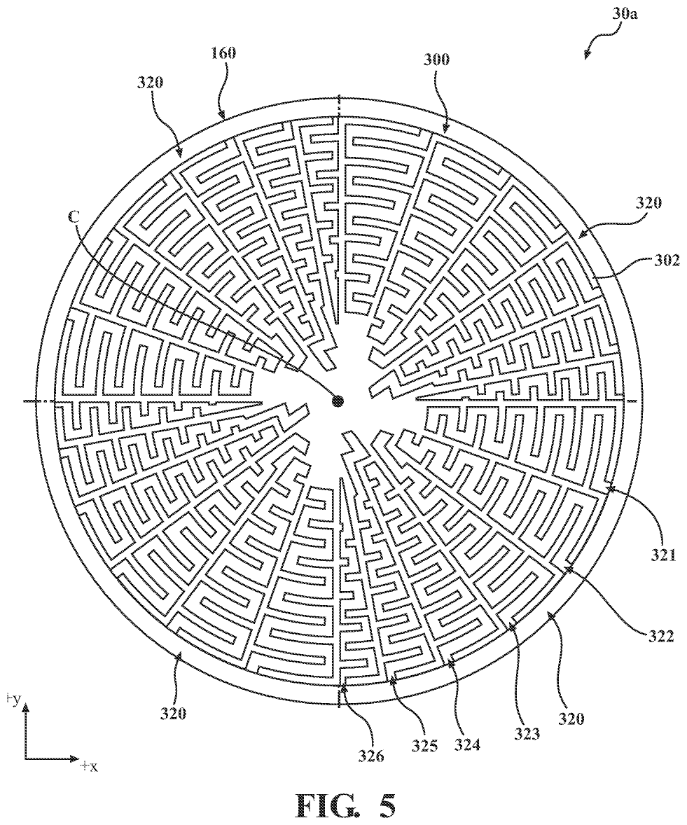

Referring to FIG. 5, a top view of an angle independent broadband acoustic structure 30a according to another form of the present disclosure is shown. The acoustic structure 30a includes an acoustic scatterer 300 with four (4) repeating cells 320 extending between a central axis ‘C’ and an outer surface 302 and foam 160 extending continuously along the outer surface 302 of the acoustic scatterer 300. In some variations, the outer surface 302 forms or is an outer circumference of the acoustic scatterer 300. And in at least one variation, the acoustic scatterer 300 includes one or two cover plates (not shown) permanently or semi-permanently attached to one or both ends of the acoustic scatterer 300. However, and in contrast to the acoustic scatterer 200, each repeating cell 320 of the acoustic scatterer 300 includes six resonant channels 321-326 defined or bounded by one or more channel walls (not labeled). Also, each resonant channel 321-326 has an open end (not labeled) and a terminal end (not labeled).

The foam 160 is a sleeve or hollow cylinder of foam disposed on the acoustic scatterer 300 and open ends (not labeled) of the resonant channels 321-226 are covered by the foam 160. Accordingly, the foam 160 extends across each of the open ends. In some variations, the sleeve of foam 160 is in direct contact with the outer surface 302, while in other variations the sleeve of foam 160 is spaced apart from the outer surface 302. For example, one or more layers of one or materials (including air or any other gas) can be between the outer surface 302 and an inner surface (not labeled) of the sleeve of foam 160. However, in all variations acoustic waves propagating through space and into any of the resonant channels 321-326, pass through the foam 160 before propagating into or entering the resonant channels 321-326. Naturally, any acoustic waves exiting the resonant channels 321-326 also pass through the foam 160.

Each of the resonant channels 321-326 is distinct. For example, each of the resonant channels 321-326 have a length, width between channel walls, and/or zigzag pattern such that the first resonant channel 321 has a first resonant frequency fₒ₁, the second resonant channel 322 has a second resonant frequency f₀₂, the third resonant channel 323 has a third resonant frequency f₀₃, the fourth resonant channel 324 has a fourth resonant frequency f₀₄, the fifth resonant channel 325 has a fifth resonant frequency f₀₅, the sixth resonant channel 326 has a sixth resonant frequency f₀₅, and fₒ₁≠fₒ₂≠fₒ₃≠fₒ₄≠fₒ₅≠fₒ₆. In addition, and with the repeating cells 320 positioned or oriented about the central axis C as shown in FIG. 5, the acoustic structure 30a absorbs sound and increases STL independent of angles from which soundwaves approach and impact the acoustic scatterer 300. And while FIG. 5 shows the foam 160 extending along the outer surface 302 of the acoustic scatterer 300, it should be understood that the acoustic structure 30 can include discrete pieces of foam 162 positioned within the open ends of the resonant channels 321-326 or discrete pieces of foam 162 extending across but not positioned within open ends of the resonant channels 321-326.

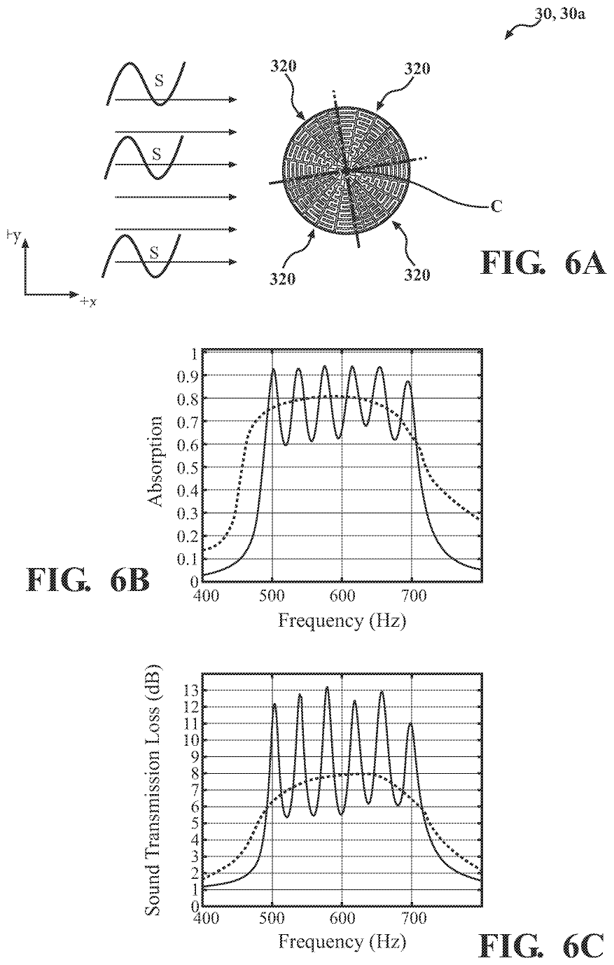

Referring to FIGS. 6A-6C, soundwaves S with frequencies between about 400 Hz and about 800 Hz propagating towards acoustic structures 30, 30a (cover plate(s) not shown) in the +x direction is shown in FIG. 6A where the acoustic structure 30 is the acoustic structure 30a without the foam 160. The simulated absorption of the soundwaves S as a function of frequency by the acoustic structures 30, 30a is shown in FIG. 6B, and the simulated STL of the soundwaves S as a function of frequency by the acoustic structures 30, 30a is shown in FIG. 6C.

Referring specifically to FIG. 6B, the acoustic structure 30 (solid line) provides broadband absorption of the soundwaves S with an average absorption of about 75% for frequencies between about 490 Hz and about 700 Hz and even higher absorption at the resonant frequencies of about 510 Hz, 540 Hz, 575 Hz, 615 Hz, 650 Hz, and 695 Hz. Also, the acoustic structure 30a provides an increase or broader broadband absorption of the soundwaves S compared to the acoustic structure 30a without the foam, reduced absorption at the frequencies of about 510 Hz, 540 Hz, 575 Hz, 615 Hz, 650 Hz, and 695 Hz, and increased absorption between the frequencies of about 510 Hz, 540 Hz, 575 Hz, 615 Hz, 650 Hz, and 695 Hz. For example, the acoustic structure 30a provides about 40% absorption for frequencies of about 450 Hz and about 740 Hz, with higher absorption between 450 Hz and 740 Hz, whereas the structure 30 provides about 7% absorption at 450 Hz and 13% absorption at 740 Hz. And as observed from FIG. 6C, the acoustic structure 30 provides STL of about 12 dB at about 510 Hz, 13 dB at 540 Hz and 575 Hz, 12.5 dB at 615 Hz, 13 dB at 650 Hz, and 11 dB at 695 Hz, while the acoustic structure 30a provides an increase or broader STL compared to the acoustic structure 30, reduced STL at the frequencies of about 510 Hz, 540 Hz, 575 Hz, 615 Hz, 650 Hz, and 695 Hz, and increased STL between the frequencies of about 510 Hz, 540 Hz, 575 Hz, 615 Hz, 650 Hz, and 695 Hz.

It should be understood that while FIGS. 6B-6C show simulated absorption and STL for the acoustic structure 30a, similar results are provided by the acoustic structure 30 with discrete pieces of foam 162 extending across open ends of the resonant channels 321-326. It should also be understood that the orientation or positioning of the four repeating cells 320 about the central axis C of the acoustic scatterer 300 provides absorption and increased STL for soundwaves propagating towards the acoustic structure 30 at different angles relative to the +x axis. That is, with the repeating cells 320 spanning 360° about the central axis C, and with each repeating cell 320 containing the six resonant channels 321-326, the acoustic scatterer 300 absorbs soundwaves and increases STL for soundwaves propagating towards the acoustic scatterer 300 from any x-z direction shown in the figures.

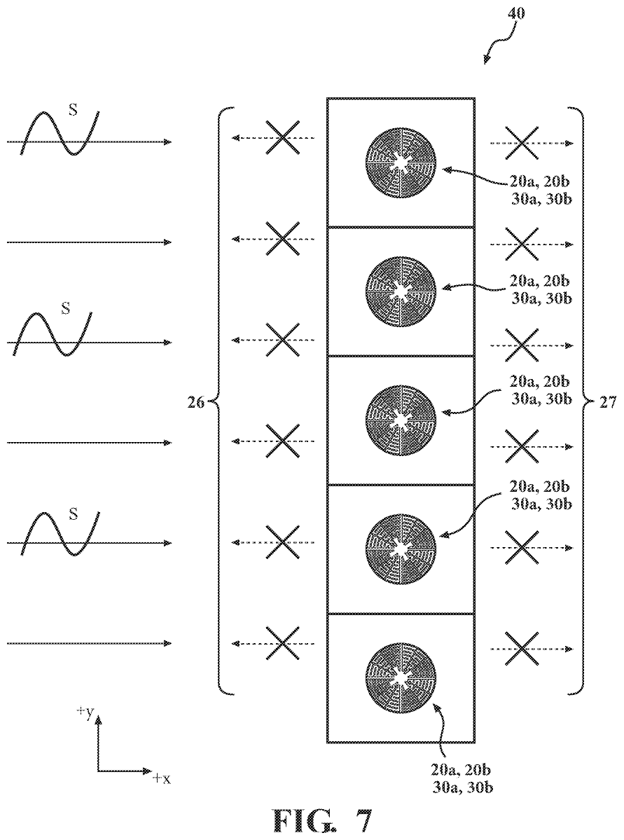

Referring to FIG. 7, an assembly 40 of a plurality of the acoustic structures 20a, 20b (cover plates not shown) or a plurality of the acoustic structures 30a, 30b (cover plates not shown) is shown where acoustic structure 30b refers to the acoustic scatterer 300 with discrete pieces of foam 162 extending across open ends of the resonant channels 321-326. In addition, FIG. 7 illustrates soundwaves S with a range of frequencies propagating towards the assembly 40, reflection of soundwaves from the assembly 40 being reduced via absorption (illustrated by the “X's through the arrows in the section labeled ‘26’) and transmission of the soundwaves through the assembly being reduced via STL (illustrated by the “X's through the arrows in the section labeled ‘27’). Accordingly, it should be understood that the acoustic scatterers according to the teachings of the present disclosure have a variety of uses such as noise barriers for and/or within infrastructures, silencers for and/or within ventilation systems, and sound absorbers in rooms, among others.

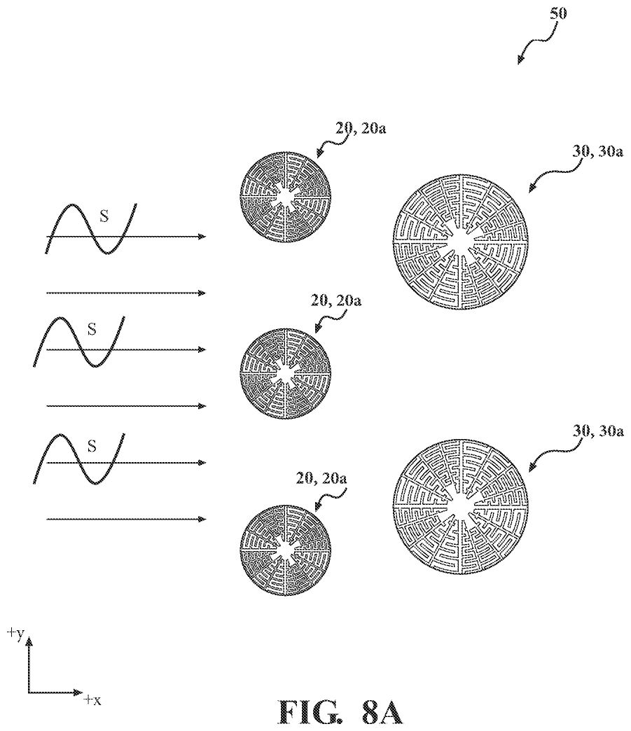

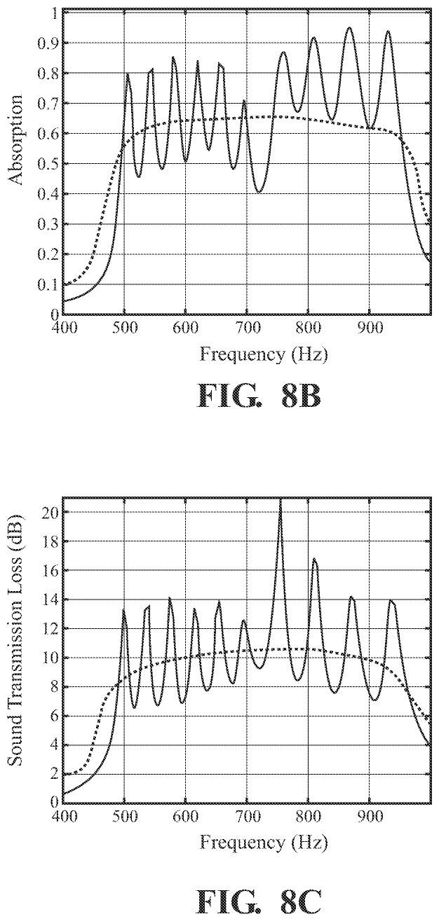

Referring to FIGS. 8A-8C, soundwaves S with frequencies between about 400 Hz and about 1000 Hz propagating towards an assembly 50 of angle independent broadband acoustic structures is shown in FIG. 8A, the simulated absorption of the soundwaves as a function of frequency by the assembly 50 is shown in FIG. 8B, and the simulated STL of the soundwaves as a function of frequency by the assembly 50 is shown in FIG. 8C. The assembly 50 includes three acoustic structures 20 or 20a (cover plates not shown) and two acoustic scatterers 30 or 30a (cover plates not shown). And as observed from FIGS. 8B-8C, the assembly 50 combines the absorption and STL of the acoustic structures 20 or 20a and the acoustic structures 30 or 30a. Particularly, and with reference to FIG. 8B, the assembly 50 with the acoustic structures 20 and 30 (solid line) provides broadband absorption of the soundwaves with an average absorption of about 75% for frequencies between about 490 Hz and about 950 Hz, and even higher absorption at the resonant frequencies of about 510 Hz, 540 Hz, 575 Hz, 615 Hz, 650 Hz, 695 Hz, 760 Hz, 810 Hz, 865 Hz, and 925 Hz. In addition, the assembly 50 with the acoustic structures 20a and 30a provides an increase or broader broadband absorption of the soundwaves S compared to the acoustic structures 20 and 30, reduced absorption at the frequencies of about 510 Hz, 540 Hz, 575 Hz, 615 Hz, 650 Hz, 695 Hz, 760 Hz, 810 Hz, 865 Hz, and 925 Hz, and increased absorption between the frequencies of about 510 Hz, 540 Hz, 575 Hz, 615 Hz, 650 Hz, 695 Hz, 760 Hz, 810 Hz, 865 Hz, and 925 Hz. For example, the acoustic structures 20a and 30a provide about 40% absorption for frequencies of about 470 Hz and about 980 Hz, with higher absorption between 470 Hz and 980 Hz, whereas the structures 20 and 30 provide about 10% absorption at 470 Hz and 20% absorption at 980 Hz.

In addition, and with reference to FIG. 8C, the assembly 50 with the acoustic structures 20 and 30 provides an increase in STL at the resonance frequencies of about 510 Hz, 540 Hz, 575 Hz, 615 Hz, 650 Hz, 695 Hz, 760 Hz, 810 Hz, 865 Hz, and 925 Hz, while the assembly 50 with the acoustic structures 20a and 30a provides an increase or broader STL compared to the acoustic structures 20 and 30, reduced STL at the frequencies of about 510 Hz, 540 Hz, 575 Hz, 615 Hz, 650 Hz, 695 Hz, 760 Hz, 810 Hz, 865 Hz, and 925 Hz, and increased STL between the frequencies of about 510 Hz, 540 Hz, 575 Hz, 615 Hz, 650 Hz, 695 Hz, 760 Hz, 810 Hz, 865 Hz, and 925 Hz.

It should be understood that while FIGS. 8B-8C show simulated absorption and STL for the acoustic structures 20a and 30a, similar results are provided by the acoustic structures 20b and 30b. It should also be understood that the orientation or positioning of the four repeating cells 220 (FIG. 1B) about the central axis C of the acoustic scatterer 200 and the four repeating cells 320 (FIG. 3) about the central axis C of the acoustic scatterer 300 provides absorption and increased STL for soundwaves propagating towards the assembly 50 at different angles relative to the +x axis. That is, with the repeating cells 220 and the repeating cells 320 spanning 360° about the respective central axis C, the assembly 50 absorbs soundwaves and increases STL for soundwaves propagating towards the acoustic structure from any x-z direction shown in the figures.

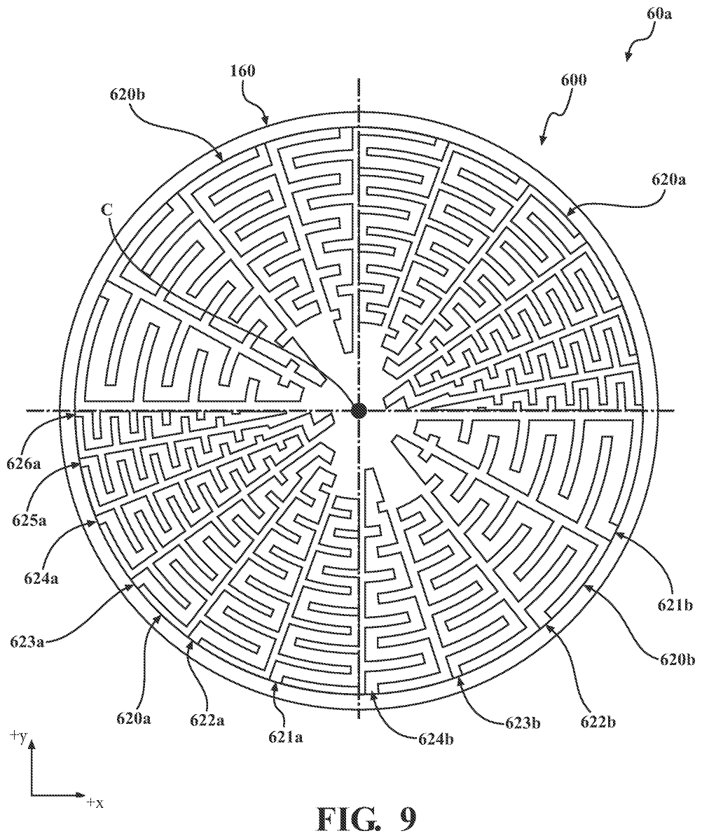

While the acoustic structures 10a, 10b, 20a, 20b, 30a, and 30b illustrate acoustics scatterers with identical repeating cells, in some variations an acoustic structure according to the teachings of the present disclosure includes non-identical repeating cells. For example, and with reference to FIG. 9, a top view (−z direction) of an acoustic structure 60a is shown. The acoustic structure 60a includes an acoustic scatterer 600 (cover plate not shown) with a sleeve of foam 160. In addition, the acoustic scatterer 600 includes two identical repeating cells 620a with six distinct resonant channels 621a-626a and two identical repeating cells 620b with four distinct resonant channels 621b-624b. In addition, the six distinct resonant channels 621a-626a have resonant frequencies of f₁ₐ≠f₂ₐ≠f₃ₐ≠f₄ₐ≠f₅ₐ≠f₆ₐ, the four distinct resonant channels 621b-624b have resonant frequencies of f_{1b}≠f_{2b}≠f_{3b}≠f_{4b}, and f₁ₐ≠f₂ₐ≠f₃ₐ≠f₄ₐ≠f₅ₐ≠f₆ₐ≠f_{1b}≠f_{2b}≠f_{3b}≠f_{4b}. Accordingly, the two identical repeating cells 620a are distinct from the two identical repeating cells 620b. It should be understood that the two identical repeating cells 620a exhibit absorption and increased STL of impinging soundwaves having frequencies corresponding to the resonant frequencies of the six distinct resonant channels 621a-626a and the two identical repeating cells 620b exhibit absorption and increased STL of impinging soundwaves having frequencies corresponding to the resonant frequencies of the four distinct resonant channels 621b-626b. It should also be understood that the foam 160, and variations discrete pieces of foam 162 are included, results in broadening of the frequency absorption and STL for soundwaves propagating towards and impinging the acoustic structure 60a.

It should be understood that variations in the types of scatterers used, the arrangement, and spacing within an acoustic structure may produce varied levels of sound absorption and transmission loss. In addition, varying the size of acoustic scatterers within acoustic structures containing multiple scatterers may improve the aggregate frequencies absorbed and improve transmission loss more than acoustic structures containing a single sized acoustic scatterer because the aggregate resonant frequencies are broader when multiple sized scatterers are present in a structure than when identically sized acoustic scatterers are present. Moreover, varying the arrangement and spacing between acoustic scatterers within an acoustic structure may alter the sound absorbed and STL of the structure.

Each acoustic structure may vary in its arrangement and angle independent acoustic structures may or may not be arranged in a manner that maximizes the absorption and transmission loss of undesirable sounds. Nonetheless, particularly where a sound originates from a single direction it may be economically beneficial to use both angle dependent acoustic scatterers and the angle independent acoustic scatterers together in the same acoustic structures. Angle independent acoustic scatterers, as disclosed herein, have at least two distinct resonant channels within repeated cells while angle dependent acoustic scatterers do not require such intricacies.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “include”, “includes”, and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms and variations. Therefore, while this disclosure includes particular examples, the true scope of the disclosure should not be so limited since other modifications will become apparent to the skilled practitioner upon a study of the specification and the following claims. Reference herein to one form or variation, or various forms or variations means that a particular feature, structure, or characteristic described in connection with a form, variation, or particular system is included in at least one form or variation. The appearances of the phrase “in one form” (or variations thereof) are not necessarily referring to the same form.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

1. An acoustic structure comprising:
an acoustic scatterer comprising a plurality of repeating cells with a corresponding plurality of resonant channels such that the acoustic scatterer is an angle independent acoustic absorber; and
foam extending along an outer surface of the acoustic scatterer.

2. The acoustic structure according to claim 1, wherein the plurality of resonant channels each comprise an open end and a terminal end, and the foam comprises discrete pieces of foam located at the open ends of the plurality of resonant channels.

3. The acoustic structure according to claim 2, wherein the discrete pieces of foam are positioned within the open ends of the plurality of resonant channels.

4. The acoustic structure according to claim 1, wherein the foam extends continuously along the outer surface of the acoustic scatterer.

5. The acoustic structure according to claim 1, wherein the foam is a sleeve of foam positioned on the outer surface of the acoustic scatterer.

6. The acoustic scatterer according to claim 1, wherein each of the plurality of repeating cells has two or more resonant channels.

7. The acoustic scatterer according to claim 6, wherein the two or more resonant channels are identical resonant channels.

8. The acoustic scatterer according to claim 6, wherein the two or more resonant channels are distinct resonant channels.

9. The acoustic structure according to claim 1, wherein the plurality of repeating cells are triangular prism shaped and positioned about a central axis of the acoustic scatterer, and the acoustic scatterer is cylindrical shaped.

10. The acoustic structure according to claim 1 further comprising a cover plate attached to an end of the acoustic scatterer.

11. The acoustic structure according to claim 10 further comprising another cover plate attached to another end of the acoustic scatterer.

12. The acoustic structure according to claim 1 further comprising a first cover plate attached to a first end of the acoustic scatterer and a second cover plate attached a second opposing end of the acoustic scatterer.

13. The acoustic structure according to claim 1, wherein the plurality of repeating cells is four repeating cells.

14. The acoustic structure according to claim 1, wherein the plurality of repeating cells are identical repeating cells.

15. The acoustic structure according to claim 1, wherein the plurality of repeating cells comprises a first set of repeating cells and a second set of repeating cells that are not identical to the first set of repeating cells.

16. An acoustic structure comprising:
a plurality of acoustic scatterers each comprising a plurality of repeating cells with a corresponding plurality of distinct resonant channels such that the plurality of acoustic scatterers are angle independent broadband acoustic scatterers; and
foam extending along an outer surface of at least one of the plurality of acoustic scatterers.

17. The acoustic structure according to claim 16, wherein the plurality of distinct resonant channels each include an open end and a terminal end, and the foam is discrete pieces of foam located at the open ends of the plurality of distinct resonant channels of the plurality of acoustic scatterers.

18. The acoustic structure according to claim 16, wherein the foam extends continuously along the outer surface of the at least one of the plurality of acoustic scatterers.

19. An acoustic structure comprising:
a cylindrical shaped acoustic scatterer comprising a plurality of repeating cells with a corresponding plurality of distinct resonant channels such that the cylindrical shaped acoustic scatterer is an angle independent broadband acoustic absorber;
two cover plates attached to opposing ends of the cylindrical shaped acoustic scatterer; and
foam extending along an outer surface of the cylindrical shaped acoustic scatterer.

20. The acoustic structure according to claim 19, wherein the foam extending along the outer surface of the cylindrical shaped acoustic scatterer is selected from the group consisting of discrete pieces of foam extending across open ends of the plurality of distinct resonant channels and a sleeve of foam extending continuously along the outer surface of the cylindrical shaped acoustic scatterer.
